(19) United States
(12) Patent Application Publication
(10) Pub. No.: US 2006/0271939 A1
(43) Pub. Date: Nov. 30, 2006

(54) Enterprise-to-enterprise integration

(76) Inventors: Eric Joris, Rumst (BE); Rick Morley, Courtice (CA); Philippe De Schrijver, Denderhoutem (BE)

Correspondence Address: FISH & RICHARDSON P.C., P.O. BOX 1022, MINNEAPOLIS, MN, 55440-1022, US

(21) Appl. No.: 11/126,939

(22) Filed: May 11, 2005

(51) Int. Cl. G06F 9/46

(52) U.S. Cl. 719/313

(57) ABSTRACT

Enterprise-to-enterprise integration may be achieved by a variety of systems and techniques. In one general aspect, a system and technique for enterprise-to-enterprise integration may include the ability to receive a message at a first message interface, the first message interface facing an enterprise, and convert the message to a format for a second message interface, the second message interface facing an enterprise partner. The system and technique may also include the ability to receive a file at an enterprise-facing file transfer interface and convert the file to a format for the second message interface.

### BACKGROUND

Automation has been useful for controlling various aspects of businesses (e.g., sales, inventory, manufacturing, and shipping) to increase safety, productivity, and reliability and control costs. The ability to automate an aspect of a business has also led to the ability to acquire information about the aspect, which may be communicated to a business partner for providing a further increase in productivity and cost control. For example, information regarding an inventory system may be sent to a parts supplier to ensure that an adequate supply of parts is constantly on hand.

Unfortunately, businesses tend to have a large number of disparate systems (e.g., sales, inventory, manufacturing, and shipping), which themselves tend to not work well with each other, although solutions to this have been attempted by establishing a central messaging hub using an open-standards protocol (e.g., electronic business Extensible Markup Language (ebXML)). Trying to link several of these systems to a business partner, therefore, is problematic. This problem is compounded even more, however, for a business that has a large number of business partners (e.g., an equipment manufacturer having thousands of retailers), because each business partner may have a different type of system for even an aspect of its business that is common to others. Thus, trying to link a business to even the same type of business partner is sometimes quite difficult. Moreover, many smaller business partners do not have the sophistication to integrate their systems with other businesses.

### SUMMARY

Enterprise-to-enterprise integration may be achieved by an integration scheme that is re-useable for a variety of enterprise partners. In one general aspect, an engine for enterprise-to-enterprise integration may include a first message interface (e.g., a Web services interface), a second message interface (e.g., an Extensible Markup Language interface), a file transfer interface (e.g., an enterprise-accessible memory drive), and a communication mapper. The first message interface and the file transfer interface may face an enterprise, and the second message interface may face an enterprise partner. The communication mapper may be coupled to the first message interface, the file transfer interface, and the second message interface and operable to convert messages and files received at the first message interface and the file transfer interface to a format for the second message interface.

The engine may further include a third message interface. The communication mapper may be coupled to the third message interface and operable to convert enterprise-generated messages received at the third message interface to a format for the second message interface. The communication mapper may also be operable to convert messages received at the second message interface to a format for the first message interface and the file transfer interface.

In certain implementations, the communication mapper may be remotely managed by communications received through the second message interface. Managing the communication mapper may include provisioning the communication mapper. The communication mapper may also be operable to validate messages received through the first message interface and/or cache enterprise-partner data.

In another general aspect, a process for enterprise-to-enterprise integration may include receiving a message at a first message interface, which faces an enterprise, and converting the message to a format for a second message interface, which faces an enterprise partner. The process may also include receiving a file at an enterprise-facing file transfer interface and converting the file to a format for the second message interface. The process may be performed by a machine, instructions stored on a machine-readable medium, or other appropriate apparatus.

The process may also include receiving an enterprise-generated message at a third message interface and converting the message to a format for the second message interface. The process may additionally include receiving a message at the second message interface and determining whether the content of the message is destined for the first message interface or the file transfer interface.

In particular implementations, the process may include receiving management instructions through the second message interface. Management instructions may, for example, include provisioning instructions. The process may also include validating messages received through the first message interface and/or caching enterprise-partner data.

Various implementations may have one or more features. For example, an enterprise-to-enterprise integration may provide a way to readily interface an enterprise with an enterprise partner, by, for instance, alleviating the need to understand all of the potential interfaces to different components of other enterprises. This may, therefore, provide a cost-effective interfacing solution for smaller enterprises. As another example, an enterprise-to-enterprise integration may be repeatedly used to integrate enterprises with an enterprise partner, even with changes in components from enterprise to enterprise. Thus, a form of the enterprise-to-enterprise integration may be reused, although it may have to provisioned appropriately for the components of each enterprise. This should increase efficiency in developing, deploying, and maintaining the enterprise-to-enterprise integration. As an additional example, components may be readily upgraded by enterprises and/or enterprise partners without having totally redevelop the integration between the new components and the preexisting components, which may provide system upgrade flexibility and system re-use. As a further example, an enterprise-to-enterprise integration may provide rules-based processing (e.g., validation by using XML schemas), remote management and monitoring (e.g., provisioning, operational changes, status updates, etc.), and/or content caching for enterprise-partner data, which may provide increased reliability and faster performance.

The details of one or more implementations are set forth in the accompanying drawings and the description below. Other features will be apparent from the description and drawings, and from the claims.

### DESCRIPTION OF DRAWINGS

FIG. 1 is a block diagram illustrating one example a system for enterprise-to-enterprise integration.

FIG. 2 is a block diagram illustrating one example of an engine for enterprise-to-enterprise integration.

FIG. 3 is a block diagram illustrating one example of a process for enterprise-to-enterprise integration.

Like reference symbols in the various drawings indicate like elements.

### DETAILED DESCRIPTION

Enterprise-to-enterprise integration may be achieved by an integration scheme that is re-useable for a variety of enterprise partners. In particular implementations, an integration engine may have a variety of message interfaces and file transfer interfaces. This may provide the engine with flexibility in interfacing an enterprise with an enterprise partner for data exchange. Other implementations, however, may have a different selection of interfaces and/or other components and features.

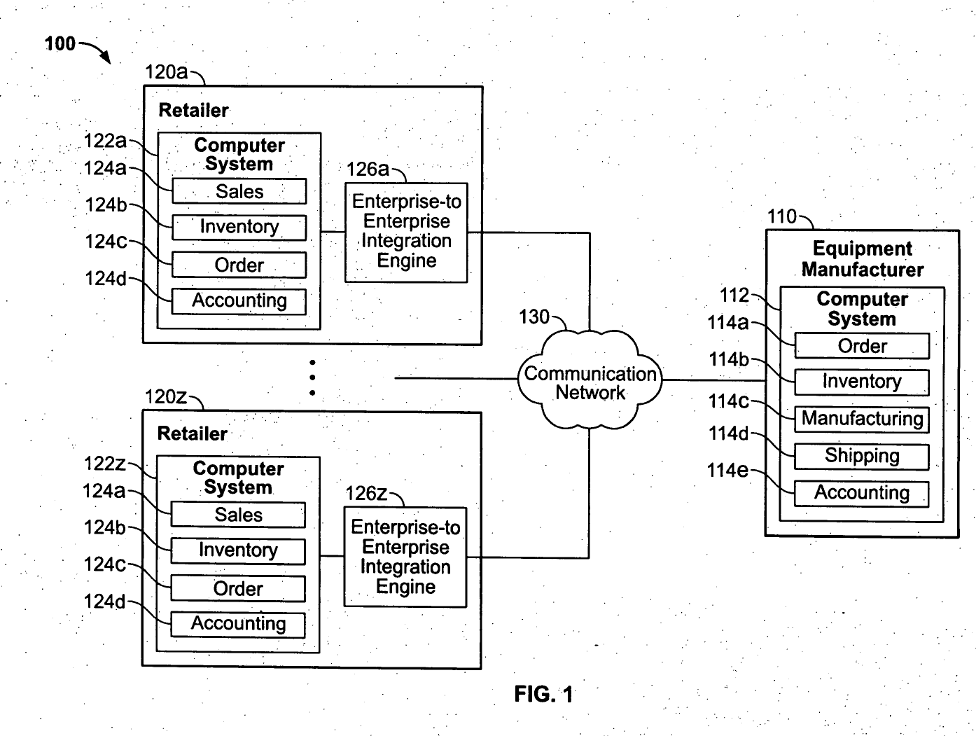

FIG. 1 illustrates a system 100 for enterprise-to-enterprise integration. In system 100, the enterprises are represented as businesses—an equipment manufacturer 110 and retailers 120. In other implementations, the enterprises may be any type of entities that need to communicate with another entities (e.g., service providers, charities, or individuals). As at least part of their business, retailers 120 sell equipment (original, replacement, or otherwise) produced by equipment manufacturer 110. Automated devices (e.g., personal computers, work stations, servers, or otherwise) of equipment manufacturer 110 may communicate with automated devices of retailers 120 through a communication network 130 (e.g., the Internet) to track one or more enterprise functions (e.g., inventory, orders, shipping, billing, and payments).

In more detail, equipment manufacturer 110 includes a computer system 112. Computer system 112 includes a variety of components 114. Components 114 may represent various functions within equipment manufacturer 112.

In this example implementation, component 114a is responsible for receiving orders from retailers 120. The orders may, for example, be for additional items produced by equipment manufacturer 110. Component 114a may interact with component 114b, which is responsible for tracking inventory, in an effort to fill the order. Component 114b may, for example, know or be able to determine the quantity of various items that the equipment manufacturer already has on hand. Component 114a may also interact with component 114c, which is responsible for manufacturing devices, in an effort to fill the order. Component 114c may, for example, schedule the ordered device for production or, possibly, produce the device. Once component 114a has filled the order, it may inform component 114d, which is responsible for shipping the ordered item. Upon shipping the ordered item, component 114e, which may be responsible for various types of financial functions (e.g., A/R, A/P, payroll, or financing), may bill the retailer that ordered the item.

Components 114 may be may be co-located or distributed. If co-located, they may be coupled together by a communication network (e.g., a local area network (LAN)) and/or reside together on a computer (e.g., a personal computer or a server). If distributed, they may also be coupled together by a communication network (e.g., a wide area network (WAN)), although several components may be co-located.

Retailers 120 also include computer systems 122. Computer systems 122 include a variety of components 124. Components 124 may represent various functions within retailers 120.

In this example implementation, component 124a is responsible for processing orders for customers. The orders may, for example, be for items produced by equipment manufacturer 110. Component 124a may interact with component 124b, which is responsible for tracking inventory, in an effort to fill the order. Component 124b may, for example, know or be able to determine the quantity of various items that a retailer already has on hand. Component 124a may also interact with component 124c, which is responsible for ordering items, in an effort to fill the order. Component 124c may, for example, place an order with component 114a of equipment manufacturer 110. Component 124b may also track the quantity of items and contact component 124c if supply is starting to run low. Once component 114a has obtained, located, and/or ordered the sought-after item, it may inform component 114d, which may be responsible for various types of financial functions, about payment for the item. Component 114d may also be responsible for coordinating payments with component 114e of equipment manufacturer 110.

Components 124 for retailers 120 may be co-located or distributed. If co-located, they may be coupled together by a communication network (e.g., LAN) and/or reside together on a computer (e.g., server). If distributed, they may also be coupled together by a communication network (e.g., WAN), although several components may be co-located. One or more of components 124 may be provided by any of a variety of retail service providers (e.g., Automated Data Processing, Inc. of Roseland, N.J.).

As illustrated in just this brief discussion of system 100, there are a variety of interactions that may occur between the components of equipment manufacturer 110 and retailers 120. Moreover, two or more of components 124 of a particular retailer 120 may interface with components 114 of equipment manufacturer 110 in different manners. Additionally, similar components between retailers 120 may interface with components 114 of equipment manufacturer 110 in different manners. Thus, there may be a variety of manners in which components 124 of retailers 120 interact with components 114 of equipment manufacturer 110.

Retailers 120 also include enterprise-to-enterprise integration engines 126. Enterprise-to-enterprise integration engines 126 are responsible for interfacing components 124 of retailers 120 with components 114 of equipment manufacturer 110. Enterprise-to-enterprise integration engines 126 may accomplish this be having a variety of communication-interface types (e.g., Web services (WS), Java Messaging Service (JMS), and File Transfer Protocol (FTP)) that are able to communicate with components 124. With these interfaces, enterprise-to-enterprise integration engines 126 may also communicate with a variety of component types. Enterprise-to-enterprise integration engines 126 may also include one or more interfaces operable to communicate with components 114 of equipment manufacturer 110. In particular implementations, enterprise-to-enterprise integration engines 126 may include an Extensible Markup Language (XML) interface (e.g., electronic business XML (ebXML) or Web services) to communicate messages to and from components 124 of retailers 120.

System 100 has a variety of features. For example, enterprise-to-enterprise interfaces 126 may provide a way to readily interface one of retailers 120 with equipment manufacturer 110. This may, therefore, provide a cost-effective integration solution for retailers 120. As another example, enterprise-to-enterprise interfaces 126 may be repeatedly used to interface retailers 120 with equipment manufacturer 110, even with changes in components from retailer to retailer. Thus, a form of the enterprise-to-enterprise interface may be reused, although it may have to provisioned appropriately for the components of each retailer 120. This should increase efficiency in developing, deploying, and maintaining the enterprise-to-enterprise interfaces. As a further example, equipment manufacturer 110 does not have to understand all of the potential interfaces to different components of retailers 120, and the retailers do not have to understand all of the potential interfaces to the components of the equipment manufacturer. As an additional example, components may be readily upgraded by either equipment manufacturer 110 or retailers 120 without having to totally redevelop the interfacing between the new components and the preexisting components.

Although FIG. 1 illustrates one implementation of a system for enterprise-to-enterprise integration, other systems may have fewer, additional, and/or a different arrangement of components. For example, other components (e.g., a customer relationship management (CRM) component, a supply chain management (SCM) component, or an item service component) could be included. As another example, one or more of components 114 of equipment manufacturer 110 or one or more of components 124 of retailers 120 could be replaced and/or consolidated into another component, such as, for example, a CRM component or an SCM component. As a further example, enterprise-to-enterprise integration engines 126 may be co-located with or remote from components 124. As an additional example, enterprise-to-enterprise integration engines 126 may allow retailers to interface with more enterprises than equipment manufacturer 110 (e.g., another equipment manufacturer or a service provider). As another example, equipment manufacturer 110 may have an integration engine to interface with its components.

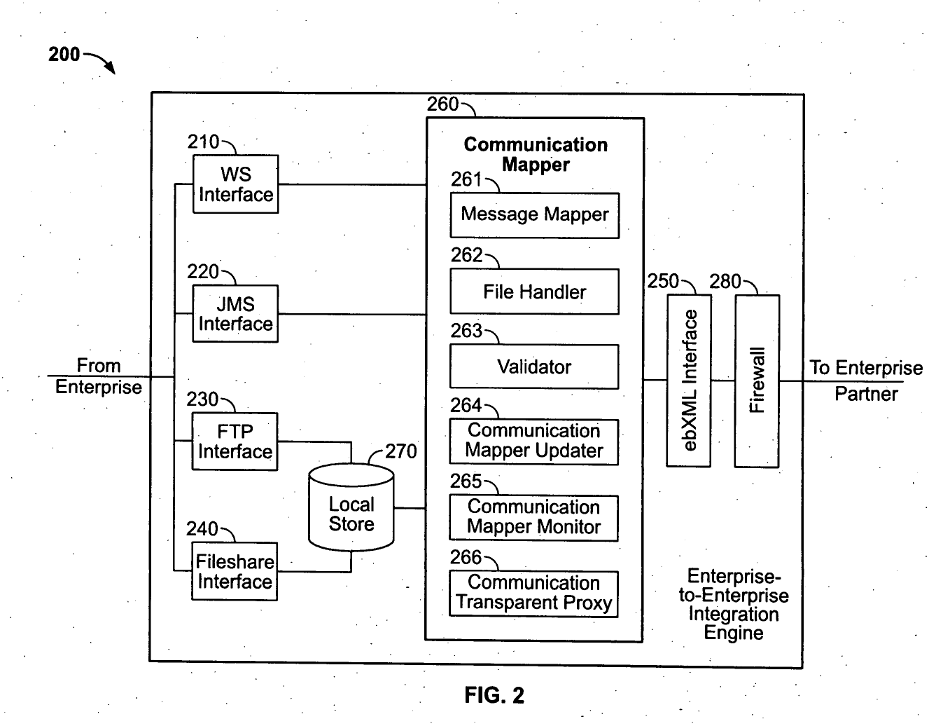

FIG. 2 illustrates an engine 200 for enterprise-to-enterprise integration. Engine 200 may be an appropriately programmed computer (e.g., PC, workstation, or server) or a program running on a computer, with or without other programs. In particular implementations, engine 200 may be based on open source software. Engine 200 may be one example of enterprise-to-enterprise integration engine 126 of system 100.

Engine 200 includes a WS interface 210, a JMS interface 220, an FTP interface 230, and a file share interface 240. These interfaces may face an enterprise type that may be from small to large in number and/or variety. The interfaces, therefore, may assist engine 200 in transferring messages and files of various types to the enterprise type. Engine 200 also includes an electronic business Extensible Markup Language (ebXML) interface 250. This interface may face an enterprise type that is small in number and/or variety and may also assist engine 200 in transferring messages and files to the enterprise type. Coupled between interfaces 210-240 and interface 250 is communication mapper 260. Communication mapper 260 is responsible mapping between the protocols of interfaces 210-240 and interface 250.

In more detail, WS interface 210 provides observable communication services. For example, WS interface 210 may list the services that it provides (e.g., through Universal Description, Discovery and Integration (UDDI)) and describe the available services (e.g., through Web services Description Language (WSDL)). In particular implementations, WS interface 210 may provide a generic interface—that is, one that is transaction neutral. WS interface 210 may accomplish this by, for example, allowing XML messages, which may include XML documents and Web services' attachments, to be sent to it. The interface may operate on the messages, documents, and attachments without regard to their contents. The interface may publish the format for communicating these data items to it.

In certain implementations, WS interface 210 may provide security measures. For example, the WS interface may provide authentication and/or authorization for messaging. Authentication may, for example, be provided by techniques such as user identifiers, passwords, and/or digital certificates (e.g., X.509). Authorization may, for example, be provided by checking authenticated messages/users against a list (e.g., a database) of permissions.

JMS interface 220 may also provide a generic interface for communicating messages, although in the Java format. JMS interface 220 may accomplish this by, for example, using a Java virtual machine to process Java messages without regard to their content. JMS interface 220 may also provide security measures.

FTP interface 230 may provide a generic manner in which to transfer files. The files may, for example, be XML files (possibly in a format that the enterprise partner publishes as a schema) or flat files. A file received through FTP interface 230 is stored in a local store 270. Local store 270 may, for example, be a hard drive, random access memory (RAM), or any other appropriate information storage device. In certain implementations, local store 270 may provide back-up or temporary storage for messages received through WS interface 210 and JMS interface 220.

Fileshare interface 240 may provide another generic manner in which to transfer files. Fileshare interface 240 may be part of engine 200 yet provide the ability for enterprise components to view local store 270 as a local storage device. Fileshare interface 240 may, for example, be a memory device that is viewable by the enterprise's components as a shared drive on a local network or a media-removable drive (e.g., a floppy drive). A file received through fileshare interface 240 may also be stored in local store 270.

In particular implementations, local store 270 may facilitate transparent caching, by which files sent from an enterprise partner are cached in local store 270. The files may then be available for the enterprise without having to access a communication network.

ebXML interface 250 provides XML-based messaging between engine 200 and an enterprise partner (e.g., a service provider). In certain implementations, ebXML interface 250 may decide between and manage synchronous and asynchronous communication to the enterprise partner. Synchronous communication may, for example, provide transactional or interactive messaging (e.g., for near real-time transactions), and asynchronous communication may provide batch messaging.

In certain implementations, ebXML interface 250 may provide security measures. For example, the ebXML interface may provide authentication and/or authorization for messaging.

Communication mapper 260 is coupled to interfaces 210-250 and responsible for mapping between the interfaces. That is, communication mapper 260 is responsible for reformatting a data item (e.g., message or file) received at one interface for another interface.

In this implementation, communication mapper 260 includes a message mapper 261, a file handler 262, and a validator 263. Message mapper 261 may be responsible for mapping communications between interfaces 210-240 and interface 250. The message mapper may, therefore, be the primary protocol switcher. In accomplishing its tasks, message mapper 261 may recognize the format of an incoming message, determine the format into which the message should be converted, and convert the message to the appropriate format. Converting the message to the appropriate format may, for example, include stripping away idiosyncrasies of one format and inserting idiosyncrasies of another format. For instance, routing information for one format may be removed and replaced by that for another format. File handler 262 may be responsible for interfacing, on a periodic or event basis, with local store 270 to handle/process message attachments (e.g., XML documents, spreadsheet files, flat files, etc.). If a file to be sent to an enterprise partner is present, message mapper 261 may map the file to a format for ebXML interface 250. To accomplish this, the message mapper may, for example, analyze a file to determine its destination (e.g., based on name) and place appropriate formatting with the file for ebXML interface 250. Validator 263 is used to validate messages and XML documents based on using XML schema's or text-based flat files that correspond to specific data format rules that can be applied. In particular implementations, a schema for validating enterprise-generated messages may be downloaded from an enterprise partner.

Communication mapper 260 also includes a communication mapper updater 264, a communication mapper monitor 265, and a communication transparent proxy 266. Communication mapper updater 264 may allow various types of modifications (e.g., patches, configuration changes, new rules, certificate updates, schemas/rules downloads, etc.) to be applied to communication mapper 260 to provision and update the communication mapper's operations (e.g., authentication, authorization, mapping, and caching).

Communication mapper updater 264 may also allow enterprise-to-enterprise engine 200 to be remotely managed (e.g., provisioned, monitored, diagnosed and maintained). Through this management, for example, the mapping between interfaces may be adjusted, the operation of the interfaces may be adjusted, and the operation of firewall 280 may be adjusted. In certain implementations, a particular mapping component may exist for interpreting these communications. Maintenance may be performed by downloading patches and scripts and installing new programs. In particular implementations, communication mapper updater 264 may allow an enterprise profile, which may be readily configured to the specific enterprise, to be managed centrally and downloaded at installation. Also, communication mapper updater 264 may download a schema to one or more enterprise components, allowing the components to format messages appropriately for the enterprise partner. To accomplish remote management, a remote computer may access engine 200 through firewall 280. The management messages may be in any appropriate protocol (e.g., ebXML or Simple Object Access Protocol (SOAP), which may be sent using the secure HyperText Transfer Protocol (HTTPS)).

Communication mapper monitor 265 may be used to remotely monitor and interact with other components to support the execution of engine 200. For example, monitor 265 may monitor the status (e.g., the number of messages being sent, the backlog of messages, etc.) and health (e.g., active, running, or locked, etc.) of various components. Messages regarding the status and health of the components may be provided on a periodic or event-driven basis. Messages to monitor 265 may be first directed to message mapper 261, which may then route the messages to monitor 265.

Communication transparent proxy 266 may be used to cache data provided from an enterprise partner to engine 200. In particular, the enterprise partner may send files/content to engine 200 through firewall 280. The data messages may be in any appropriate protocol (e.g., ebXML or Simple Object Access Protocol (SOAP), which may be sent using the secure HyperText Transfer Protocol (HTTPS)), and the data may be cached in local store 270 by communication mapper updater 264, which may also be used to update the data. Thus, when the enterprise requests this data, communication transparent proxy 266 may make the data available without having to access a communication network, which may provide an increase in processing performance and/or a decrease in network bandwidth.

Engine 200 also includes a firewall 280. Firewall 280 may be responsible for preventing unauthorized messages from entering or leaving engine 200.

In one mode of operation, engine 200 receives messages, which may include files and/or attachments, at WS interface 210. Message mapper 261 then maps the message to an appropriate format for ebXML interface 250, and possibly stores the message in local store 270. ebXML interface 250 may then open a communication network connection through firewall 280 and send the message, possibly with the help of file handler 262 if a message or attachment is involved, to the enterprise partner. Messages received at JMS interface 220 may be treated similarly.

Files may also be communicated to the enterprise partner by receiving them at FTP interface 230 and/or fileshare interface 240. Files received at these interfaces are stored at local store 270. File handler 262 may examine local store 270, based on a period-driven basis, an event-driven basis, or otherwise, and determine how to move the file (e.g., based on its naming). Message mapper 261 then processes (e.g., encapsulates) the file appropriately for ebXML interface 250 and moves the processed file to the interface. ebXML interface 250 may then send the file through firewall 280 to the enterprise partner.

ebXML interface 250 may also receive messages from the enterprise partner through firewall 280. Upon receipt, the interface may send a message to communication mapper 260, at which message mapper 261 may determine which type of interface is appropriate for the message. Message mapper 261 may also format the file for the appropriate interface. For example, message mapper 261 may remove headers from a file and place the file in local store 270. A component of the enterprise system may then retrieve the file through FTP interface 230 or fileshare interface 240.

As one example of provisioning, validator 263 may be modified to provide validation and parsing, by, for example, installing a schema validator. Thus, a message destined for the enterprise partner may be analyzed before sending the message. Also, a message from the enterprise partner may be analyzed before passing the message to the enterprise system. In particular implementations, such operations may be based on specifications of the enterprise partner, which may be accessed automatically by ebXML interface 250. ebXML interface 250 may also provide error reporting.

Enterprise-to-enterprise integration engine 200 has a variety of features. For example, interfaces 210-240 provide a way to readily interface an enterprise with an enterprise partner, especially with using open-standards interfaces as in this example. For instance, the activation sequence for the engine may include installing the engine on a computer coupled to a LAN, configuring the programs accessing the LAN to see the interfaces, if necessary, and establishing a communication network (e.g., Internet) connection from the computer. As another example, enterprise-to-enterprise integration engine 200 may be repeatedly used for different enterprises, even with the changes in components from enterprise to enterprise. Thus, a form of the enterprise-to-enterprise integration engine may be reused, although it may have to provisioned appropriately for the components of each enterprise. This should increase efficiency in developing, deploying, and maintaining the enterprise-to-enterprise interfaces. As a further example, components may be readily upgraded by the enterprise partner or the enterprise without having to totally redevelop the interfacing between the new components and the preexisting components. As an additional example, the engine may provide a very low footprint when installed at the enterprise site while still being remotely manageable. As another example, message exchange may be secure and reliable. Furthermore, the complexity of reliable and secure communication over the Internet (e.g., authentication, confidentiality, non-repudiation, guaranteed delivery) may be handled transparently to the enterprise (e.g., ebXML interface 250).

Although FIG. 2 illustrates an enterprise-to-enterprise integration engine 200, other implementations may include fewer, additional, and/or a different arrangement of components. For example, one or more of interfaces 210-240 may be removed (e.g., JMS interface 220 or fileshare interface 240). As another example, other interfaces could be added. As a further example, a different type of enterprise partner interface could be used (e.g., WS). As an additional example, various components could be combined with each other (e.g., communication mapper updater 264 and communication mapper monitor 265 could be collapsed to one component). As another example, communication mapper 260 may perform its operations in a content-neutral manner—that is, it may stream the content of a communication without analyzing the content (message, file, or attachment) of the communication—and, hence, not need validator 263. In particular implementations, however, communication mapper 260 may perform some operations in a content-neutral manner and some operations in a content-determinative manner. As a further example, the communication mapper may include the ability to compress, perhaps through a particularized component, at least certain types of communications, which may provide enhanced performance through conservation of bandwidth. Compression may be achieved by using any appropriate type of compression algorithm (e.g., Java-implemented gzip).

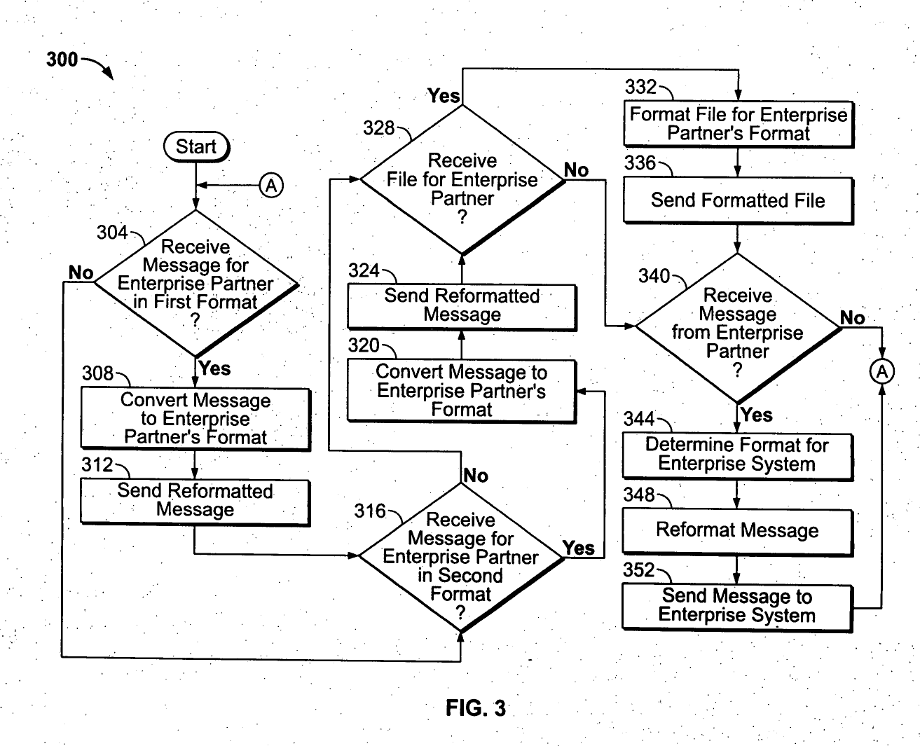

FIG. 3 illustrates a process 300 for enterprise-to-enterprise integration. Process 300 may, for example, illustrate one mode of operation of enterprise-to-enterprise engines 126 of system 100.

Process 300 begins with determining whether a message for an enterprise partner in a first format has been received (operation 304). The enterprise partner may, for example, be a service provider, and the message may be an XML message, which may include an associated file or attachment. If a message for an enterprise partner in a first format has been received, process 300 calls for converting the message to the enterprise partner's format (operation 308). Converting the message to the enterprise partner's format may, for example, include removing header information for the first format and inserting header information for the enterprise partner's format. Process 300 also calls for sending the reformatted message (operation 312).

If a message for an enterprise partner in a first format has not been received (operation 304), of if the reformatted message has been sent (operation 312), process 300 continues with determining whether a message for an enterprise partner in a second format has been received (operation 316). If a message for an enterprise partner in a second format has been received, process 300 calls for converting the message to the enterprise partner's format (operation 320). Process 300 also calls for sending the reformatted message (operation 324).

If a message for an enterprise partner in a second format has not been received (operation 316), or if a reformatted message has been sent (operation 324), process 300 continues with determining whether a file for an enterprise partner has been received (operation 328). A file for an enterprise partner may, for example, have been received by a transfer (e.g., FTP) or placement onto a shared memory device. If a file for an enterprise partner has been received, process 300 calls for formatting the file for the enterprise partner's format (operation 332) and sending the formatted file (operation 336). For example, a data file (e.g., a text document, a spreadsheet, or a database) may be wrapped in an XML header.

If a file for an enterprise partner has not been received (operation 328), or if a formatted file has been sent (operation 336), process 300 continues with determining whether a message has been received from the enterprise partner (operation 340). If a message has not been received from the enterprise partner, process 300 calls for checking whether a message for the enterprise partner in a first format has been received (operation 304). If, however, a message from the enterprise partner has been received, process 300 calls for determining the appropriate format for the enterprise system (operation 344). For example, the message may need to be converted to an XML or Java format. The message may then be reformatted to the enterprise format (operation 348) and sent to the enterprise system (operation 352), and process 300 calls for checking whether a message for an enterprise partner in a first format has been received (operation 304).

Although FIG. 3 illustrates one process for enterprise-to-enterprise integration, other processes for enterprise-to-enterprise integration may include fewer, additional, and/or a different arrangement of operations. For example, a process may not call for determining whether a message in a second format has been received. As another example, a process may not call for determining whether a file for an enterprise partner has been received. As a further example, a process may call for determining whether a message in a third format has been received. As an additional example, determining whether messages or files have been received may occur in any order. In general, the logic flow depicted in FIG. 3 does not require the particular order shown, or sequential order, to achieve desirable results. In certain implementations, moreover, multitasking and parallel processing may be preferable.

Various implementations of the described systems and techniques described may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user by an output device may be any form of sensory feedback (e.g., visual feedback, auditory feedback, or tactile feedback); and input from the user may be received in any form, including acoustic, speech, or tactile input.

The systems and techniques described here may be implemented in a computing system that includes a back end component (e.g., as a data server), or that includes a middleware component (e.g., an application server), or that includes a front end component (e.g., a client computer having a graphical user interface or a Web browser through which a user may interact with an implementation of the systems and techniques described here), or any combination of such back end, middleware, or front end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

Several implementations have been discussed, and a number of other implementations have been mentioned or suggested. Furthermore, a variety of additions, deletions, substitutions, and/or modifications to these implementations will be readily suggested to those skilled in the art while still achieving enterprise-to-enterprise integration. For at least these reasons, the invention is to be measured by the following claims, which may include one or more of these implementations.

1. An enterprise-to-enterprise integration engine, the engine comprising:
a first message interface, the first message interface facing an enterprise;
an enterprise-facing file transfer interface;
a second message interface, the second message interface facing an enterprise partner; and
a communication mapper coupled to the first message interface, the file transfer interface, and the second message interface, the communication mapper operable to convert messages and files received at the first message interface and the file transfer interface to a format for the second message interface.

2. The engine of claim 1, wherein the first message interface comprises a Web services interface.

3. The engine of claim 1, wherein the file transfer interface comprises an enterprise-accessible memory drive.

4. The engine of claim 1, wherein the second message interface comprises an Extensible Markup Language interface.

5. The engine of claim 1, further comprising a third message interface, the communication mapper coupled to the third message interface and operable to convert enterprise-generated messages received at the third message interface to a format for the second message interface.

6. The engine of claim 1, wherein the communication mapper is operable to convert messages received at the second message interface to a format for the first message interface and the file transfer interface.

7. The engine of claim 1, wherein the communication mapper may be remotely managed by communications received through the second message interface.

8. The engine of claim 7, wherein managing the communication mapper includes provisioning the communication mapper.

9. The engine of claim 1, wherein the communication mapper is operable to validate messages received through the first message interface.

10. The engine of claim 1, wherein the communication mapper is operable to cache enterprise-partner data.

11. A method for enterprise-to-enterprise integration, the method comprising:
receiving a message at a first message interface, the first message interface facing an enterprise;
converting the message to a format for a second message interface, the second message interface facing an enterprise partner;
receiving a file at an enterprise-facing file transfer interface; and
converting the file to a format for the second message interface.

12. The method of claim 11, further comprising:
receiving an enterprise-generated message at a third message interface; and
converting the message to a format for the second message interface.

13. The method of claim 11, further comprising:
receiving a message at the second message interface; and
determining whether the content of the message is destined for the first message interface or the file transfer interface.

14. The method of claim 11, further comprising receiving management instructions through the second message interface.

15. The method of claim 14, wherein the management instructions comprise provisioning instructions.

16. The method of claim 11, further comprising validating messages received through the first message interface.

17. The method of claim 11, further comprising caching enterprise-partner data.

18. An article comprising a machine-readable medium storing instructions operable to cause one or more machines to perform operations comprising:
determining whether a message has been received at a first message interface, the first message interface facing an enterprise;
converting the message to a format for a second message interface, the second message interface facing an enterprise partner;
determining whether a file has been received at an enterprise-facing file transfer interface; and
converting the file to a format for the second message interface.

19. The article of claim 18, wherein the instructions are further operable to cause one or more machines to perform operations comprising:
determining whether an enterprise-generated message has been received at a third message interface; and
converting the message to a format for the second message interface.

20. The article of claim 18, wherein the instructions are further operable to cause one or more machines to perform operation comprising:
determining whether a message has been received at the second message interface; and
determining whether the content of the message is destined for the first message interface or the file transfer interface.
